(19) United States
(12) Patent Application Publication
(10) Pub. No.: US 2012/0224116 A1
(43) Pub. Date: Sep. 6, 2012

(54) MENU DISPLAY CABINET

(76) Inventor: Michael S. Barnes, Kennesaw, GA (US)

(21) Appl. No.: 13/366,114

(22) Filed: Feb. 3, 2012

Related U.S. Application Data
(60) Provisional application No. 61/439,261, filed on Feb. 3, 2011.

(51) Int. Cl. G02F 1/13357; F21V 21/00

(52) U.S. Cl. 349/58; 362/362; 362/370

(57) ABSTRACT

A modular display for housing both digital and static display is disclosed herein. The modular display includes a cabinet having an external frame and a display chassis. The display chassis is shaped and sized so that it can be selectively inserted into and selectively coupled to the external frame of the cabinet. Both a static display chassis and a digital display chassis serve as display chassis that can interchanged within the modular display. The static display chassis housing includes a static light source and a static display. The digital display chassis housing includes a digital display.

### RELATED APPLICATIONS

This application claims priority to U.S. Provisional Patent Application Ser. No. 61/439,261 filed Feb. 3, 2012 entitled, “Menu Display Cabinet.”

### BACKGROUND OF THE INVENTION

The invention relates to modular, illuminated displays for presenting advertisements, promotional materials, and other information.

Many businesses utilize signs to present advertisements, promotional materials, menu items, and specials. Such signs are common features of restaurants, stores, and drive-thru businesses. Due to the nature of these businesses, it may be beneficial to occasionally or frequently change or update the information presented on such displays.

Traditional static displays require manual modifications of the display, while digital display, such as liquid crystal display (LCD), LED-LCD displays, plasma, cathode ray tube (CRT), digital light processing (DLP) display, or similar display devices are changed electronically. Digital displays can receive updated information without directly accessing the display unit itself. Despite the advances in digital displays, static displays continue to have many advantages over digital display technologies in a variety of circumstances. For instance, when the contents of a display is constant over long periods of time, static displays can be less expensive, require less maintenance, have a clearer image, and may be viewed from a larger range of angles. Because digital displays and static displays each have distinct advantages, business owners must choose between them when installing a display in or around their business.

### SUMMARY

The modular display, as described herein, allows a display structure to be quickly and efficiently changed from a digital display to a static display or vice versa without replacing the entire display structure. Such versatility enables a rapid and frequent modification of a display system that may create vitality and freshness to business, storefront, or drive-thru experience.

In one aspect, a modular display includes a cabinet having an external frame. A display chassis is shaped and sized to be selectively inserted and selectively coupled to the external frame of the cabinet. The display chassis can interchangeably include a static display chassis or a digital display chassis. The static display chassis houses a static light source and a static display. The digital display chassis houses a digital display.

In some implementations, a plurality of mounting brackets may be disposed on the external frame. The display chassis may have a plurality of slots shaped and sized to mate with the plurality of mounting brackets. The plurality of mounting brackets may be oriented inwardly with respect to the cabinet. Additionally, the cabinet may include a front and rear door attached to a front and rear side of the cabinet. The front and rear doors may be shaped and sized to secure at least one of the static display and digital display within the cabinet. Also, the digital display may be a LCD display.

In some aspects, a display cabinet includes a cabinet cooling system for maintaining desirable temperatures inside the cabinet while reducing excess moisture. Thus, a cabinet body can include a thermostat control device functionally connected to the cabinet cooling system to allow for accurate measurement and control of the internal temperature of various components of the display device, power supplies, and a video control board for storing various video displays at the sign.

In some implementations, one or more air channels may be provided through the interior of the display cabinet to allow air to flow between an LCD display and other components of the display device. One or more vents may provide circulation of air effectively venting off any hot air build up inside the device. One or more fans may also be included within the display cabinet to circulate air therein.

### BRIEF DESCRIPTION OF THE SEVERAL VIEWS OF THE DRAWINGS

In order that the manner in which the above-recited and other features and advantages of the invention are obtained and will be readily understood, a more particular description of the invention briefly described above will be rendered by reference to specific embodiments thereof, which are depicted in the appended Figures. Understanding that these Figures depict only typical embodiments of the invention and are not, therefore, to be considered to be limiting of its scope, the invention will be described and explained with additional specificity and detail through the use of the accompanying Figures in which:

FIG. 1 illustrates a perspective view of an outdoor display according to a representative embodiment.

FIG. 2 illustrates an exploded perspective view of a static display and a digital display according to representative embodiments.

FIG. 3 illustrates several different views of a static chassis, including a layout, perspective (“isometric”), top, side, and bottom views according to representative embodiments.

FIG. 4 illustrates several different views of a lower light bar, including a layout, perspective (“isometric”), top, side, and bottom views according to representative embodiments.

FIG. 5 illustrates several different views of a rotate plate, including a layout, perspective (“isometric”), top, side, and bottom views according to representative embodiments.

FIG. 6 illustrates several different views of a side mount bracket, including a layout, perspective (“isometric”), top, side, and bottom views according to representative embodiments.

FIG. 7 illustrates several different views of an upper light bracket, including a layout, perspective (“isometric”), top, side, and bottom views according to representative embodiments.

FIG. 8 illustrates several different views of a lower light mounting bracket, including a layout, perspective (“isometric”), top, side, and bottom views according to representative embodiments.

FIG. 9 illustrates several different views of a display cabinet according to representative embodiments.

FIG. 10 illustrates a top sectional view of a display cabinet according to representative embodiments.

FIG. 11 illustrates an exploded view of a display cabinet according to representative embodiments.

FIG. 12 illustrates a cross sectional view of a top portion of a display cabinet having cooling system components according to representative embodiments.

FIG. 13 illustrates a rear view of a display cabinet according to representative embodiments.

FIG. 14 illustrates several different views of a display cabinet according to representative embodiments.

FIG. 15 illustrates several different views of a display cabinet according to representative embodiments.

FIG. 16 illustrates top view of a hinge and several cross sectional views of a display cabinet having a hinge according to representative embodiments.

FIG. 17 illustrates cross sectional views of a double face cabinet and a single face cabinet according to representative embodiments.

FIG. 18 illustrates a perspective view of a corner of a display cabinet according to representative embodiments.

FIG. 19 illustrates a perspective view of an outdoor display according to representative embodiments.

FIG. 20 illustrates a front a side view of an outdoor display according to representative embodiments.

### DETAILED DESCRIPTION OF THE INVENTION

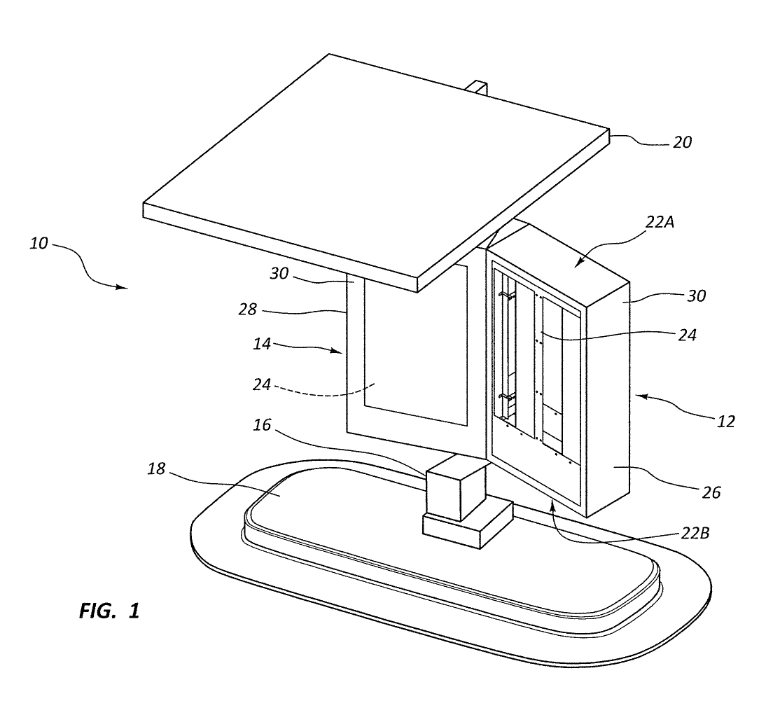

The invention relates to modular, illuminated display devices for presentation of advertisements, informational, and promotional materials. FIG. 1 illustrates a representative modular display 10 having two display panels: a static display 12 and a digital display 14. A static display 12, refer to a traditional display type in which the display is modified, if at all, by physically modifications and which includes physical display features, such as paint, plastics, stencils, and printed images, as opposed to images displayed on an electronic, digital display. On the other hand, a digital display 14 refers to a television, or other electronic display screen that displays images using digital technologies, such as liquid crystal display (LCD), LED-LCD display, plasma, cathode ray tube (CRT), or digital light processing (DLP) display technologies.

While not specifically illustrated or described herein, it will be noted that a variety of combinations of digital and static components can be included in a single display panel. For example, a display panel can include both a digital display and a static display. For instance, a digital display portion and a static display portion. Other layout of such combination panels can be utilized with the modular display 10. As used herein the term “digital display” includes a reference to these combinations displays as well as purely digital displays.

As discussed above, static and digital displays each have unique features which may be deemed more appropriate than the other in certain situations. Accordingly, the modular display 10 enables a display owner to interchange a digital display 14 with a static display 12 or a static display 12 with a digital display 14. The ability to interchange the static and digital displays is facilitated by a common display cabinet 24, which receives and supports both types of displays. Thus, the display 10 is a modular display since it uses a display cabinet 24 as a standardized unit that support that multiple types of displays and thus provides flexibility to the display system 10.

FIG. 1 illustrates some representative components of a display structure. As shown, the display of FIG. 1 is a stand-alone outdoor display 10. However, it will be recognized that the display cabinet 24 could be placed indoors or be supported by another structure, such as a building or wall. For example, a modular display can be located on a wall or hanging from a ceiling. In one representative example, a modular display is located outside a movie theater to display movie posters, movie times, and/or prices. In another example, the modular display is placed at a roadside location to display messaged to passing by drivers and pedestrians.

Referring again to FIG. 1, the modular display 10 as illustrated represents a drive-thru display situated on a raised curb 18. The modular display 10 includes two display panels 12 and 14. Drivers and passengers in a vehicle can approach the modular display 10 and communicate with agents of the drive-thru business via a speaker/intercom system 16 associated with the modular display 10. The speaker/intercom system 16 can be located nearly anywhere among the display 10, such as near the ground, as illustrated.

The display 10 supports an awning 20 that is placed at a height and sized to avoid vehicles, but also to shade the displays from direct sun and/or glare. The awning may be protect a digital display 14 from direct sunlight as well as heat associated therewith, which might impair the function of the digital display in extreme weather or over prolonged exposure periods.

As illustrated, the modular display 10 supports two separate display panels 12 and 14. However, in other embodiments, the modular display supports one, three, four, five, six, or more display panels. Each of the display panels is physically and electronically supported by one or more support members 22. The illustrated representation includes a top 22A and bottom 22B support member. In some embodiments, the display panel is supported only via a top support member 22A. In other embodiments, the display panel is supported only via a bottom support member 22A. In still other embodiments, the display panel is supported via one or more side support members (not shown).

The support members 22 may provide both structural and electronic support to the display panel(s). Accordingly, the physical properties and connector components of the support member 22 can be selected to physically support and balance the display despite hazardous outdoor environments, such as heavy winds and snow. Additionally, in some embodiments, the support member 22 house electrical wires which run through the interior of the support member and into the display panel. Thus, in some embodiments, the support member is hollow so that wires and/or cables can be fed therethrough.

The support members 22 can support the display panels 12 and 14 in a rotatable fashion, so that the display can rotate along its central vertical axis. In some embodiments, a display panel can rotate up to 360 degrees, 180 degrees in both directions from an initial forward facing orientation. In other embodiments, the display panel can rotated up to 180 degrees, 90 degrees in both directions from an initial forward facing orientation. In other embodiments, the display panel rotates anywhere between 1-360 degrees. In other embodiments, the display can rotate an unlimited degree without limitation.

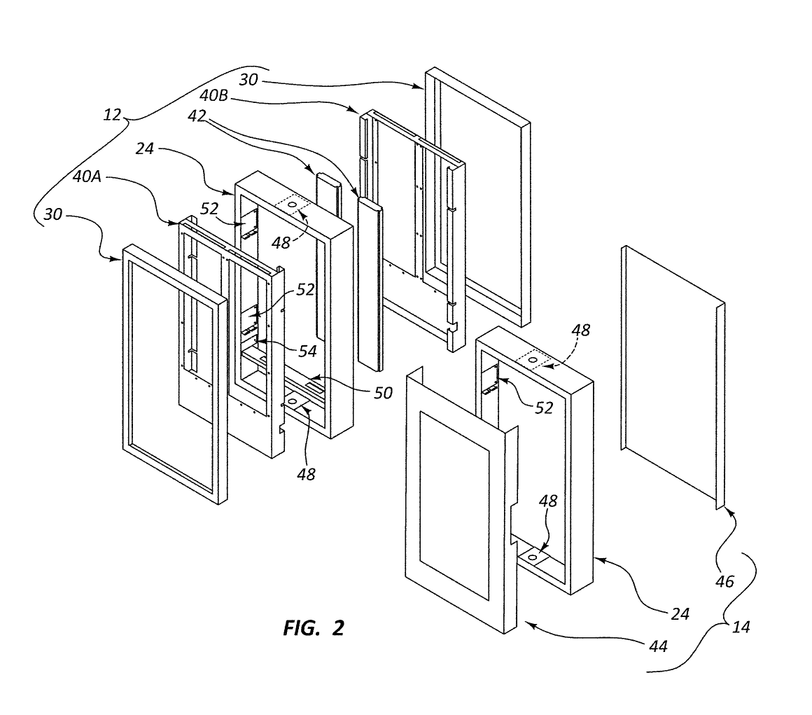

In some embodiments, the connection between the support member 22 and the cabinet 24 is supported by a rotate plate 48, as shown in FIG. 2. This rotate plate can reinforce this central portion of the cabinet 24, which might in other instances be a weak point or stress point. In some embodiments this plate 48 is made of a metal, such as steel or stainless steel, and is fastened to the cabinet, such as via a weld.

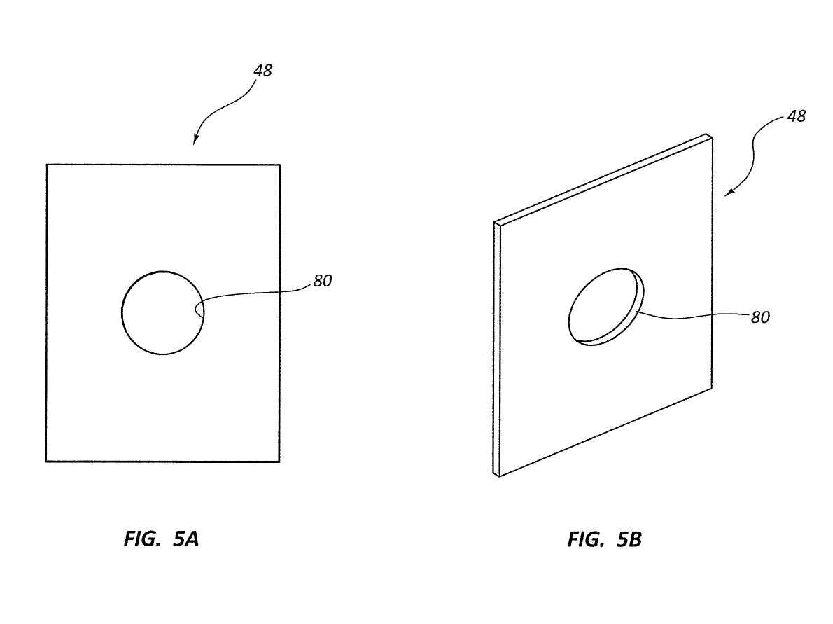

Referring still to FIG. 1, to support a rotating display panel, the support member 24 and/or the display panel can include a rotary electrical connector (not shown) that enables the display to rotate without twisting wires running between the support member 22 and the display panel 12 or 14. In some embodiments, the rotary connector is disposed between the display cabinet 24 and the support member 22. In some embodiments, the rotary connector is disposed on or within a hole 80 in a rotating plate 48 disposed on the cabinet, such as that illustrated in FIG. 5. The rotary connector may connect one or more conductor lines, including data lines. Some rotary connectors implement brush slip rings composed of a rotating metal ring upon which a graphite or metal brush rubs and transfers the electrical signal or current. Other rotary connectors utilize a liquid metal which is molecularly bonded to contacts, such as the Mercotac® Rotary Electrical Connectors, from Mercotac, Inc. Optical rotary connectors may also be utilized, which enable the transmission of data for a digital display panel 14, such as that discussed in “Optical rotary connector for transfer of data signals from fiber optic sensors plasing on rotary objects,” Proc. SPIE Vol. 1589, p. 24-31, Specialty Fiber Optic Systems for Mobile Platforms, Norris E. Lewis; Emery L. Moore; Eds.

In some embodiments, a modular display 10 receives digital data for a digital display 14 via a wireless connection (not shown). A wireless connection may facilitate the physical wire requirements for rotary and non-rotary display panels. Furthermore, wireless transmission of data to a display may decrease installation costs and complexity.

As mentioned above, the modular display 10 facilitates interchangeability between a static 12 and a digital 14 display. This replacement process will be described here in general terms and steps, and later, with reference to FIG. 2, this process will be described in greater detail. Accordingly, when a user replaces, for example, a static display panel 12 with a digital display panel 14, the user opens a door 30 located on either the front and/or back side of the display cabinet 24. The door serves, like a frame, to enclose and support a static 26 or digital 28 chassis within the cabinet 24. Once the door is opened, the user may disconnect the static chassis 26 electronically and structurally from the cabinet 24 and then remove the static chassis 26 from the cabinet 24. In some alternative embodiments, one or more doors are not incorporated into the cabinet 24, but rather the chassis 26 or 28 is supported within the cabinet 24 with mechanical fasteners and/or interlocks.

Once the former display chassis is removed from cabinet 24, the user may insert the desired chassis, for example a digital chassis 28 into the cabinet 24. Once inserted therein, the chassis can be coupled to the cabinet or interlocked therein and connected to any electronic connectors therein. If a door is included with the cabinet the door is closed. In some embodiments, the door includes a lock that secures the door in a closed position to retain the chassis therein and prevent theft, vandalism, and other tampering with the chassis. Once the door is closed or the chassis is coupled to the cabinet (if there is no door once) the replacement process is complete.

In light of the foregoing it will be understood that the process of interchanging digital and static displays is facilitated by standardized sizes and shapes of the display cabinet and the display chassis. For instance, in some embodiments, the cabinet 24 is formed of a substantially rectangular frame having a substantially empty inner area therein that receives a digital/static chassis (28/26). This inner area includes an inner surface having lengths and widths that approximates the lengths and widths of the outer surface of the chassis. Thus, the chassis can be inserted into the inner area of the cabinet 24 with only minor spacing therebetween. Furthermore, in some embodiments, the inner surface of the cabinet includes structural components that interlock with structural components on the outer surface of the chassis. These structural components can include support brackets, support plates, channels, grooves, or other like components.

Once inserted into the cabinet 24, the chassis (26 or 28) can be maintained therein via a door or coupling and/or interlocking components between the chassis and cabinet. Alternatively, in some embodiments, the chassis includes two portions, a front and back portion, which are coupled together within the cabinet. When these two portions are connected they can lock (or sandwich) together to hold one or more structural components between these two portions or to hold the chassis in position therebetween. One or more of the front and back portions of the chassis can include an interlocking structure that interlocks with one or more structural components of the cabinet. An example of interlocking structures on front and rear portions of a chassis is illustrated in FIG. 2.

FIG. 2 illustrates a representative embodiment of a static display panel 12 and a digital display panel 14. While referencing and describing FIG. 2, a more specific description of the structures and function of the modular display 10 will be provided. The exploded panel on the left is the static panel 12, the exploded panel on the right is the digital panel 14. These panels are illustrated in an exploded view that illustrates basic structural components of each display panel. Each panel is illustrated as having a common display cabinet 24 at the center of the exploded components. From FIG. 1, it will be understood that this cabinet 24 can be coupled to a modular display structure 10. The remaining components can be inserted into or attached onto the cabinet 24.

In some embodiments, the display cabinet 24 functions as a common display cabinet because it can support the different chassis types. As shown in FIG. 2, in some embodiments, the cabinet 24 is an external frame. In some embodiments, the frame is made of a U-channel support members with the channel oriented inwardly, as shown. In this configuration, various structural components can be securely inserted into or coupled within the U-channel. The U-channel can add structural strength to the cabinet while minimizing weight. In other embodiments, the cabinet frame is made of solid or hollow-centered support members. In some embodiments, the cabinet 24 is made substantially of a metal. In some instances the metal is aluminum, such as sheet aluminum that can be bent and cut to form the frame. In other embodiments, the cabinet is made of steel, stainless steel, or other metals or metal alloys.

The display cabinet 24 can have a variety of sizes and dimensions depending on the size of the display desired. In some embodiments, the cabinet 24 is sized to house a standard digital display size, such as a 32-inch, 37-inch, 42-inch, 46-inch, or 52-inch digital display screen having a 16:9 aspect ratio. In other embodiments, the cabinet 24 is sized to house other sizes of display screens, such as 12-inch×12-inch screens, or any other display screen size that would be useful in a modular display. For instance a 72-inch×72-inch screen may be useful in displaying a menu in a drive-thru digital display. Other larger or smaller displays may also be used within the modular display.

As illustrated, in some embodiments, one or more mounting brackets 52 are coupled to the cabinet 24. In some embodiments, the mounting brackets 52 support a display chassis within the cabinet. In other embodiments, the mounting brackets 52 interlock with a display chassis 40 or 44 to hold it within the cabinet. In other embodiments, a display chassis 40 or 44 is selectively coupled to the mounting brackets via screws, pins, nuts and bolts, or other fasteners, to secure the display chassis to the cabinet 24. In other embodiments, the mounting brackets 52 are secured between front and back sides of a chassis when the front and back sides are fastened together to hold the chassis within the cabinet 24.

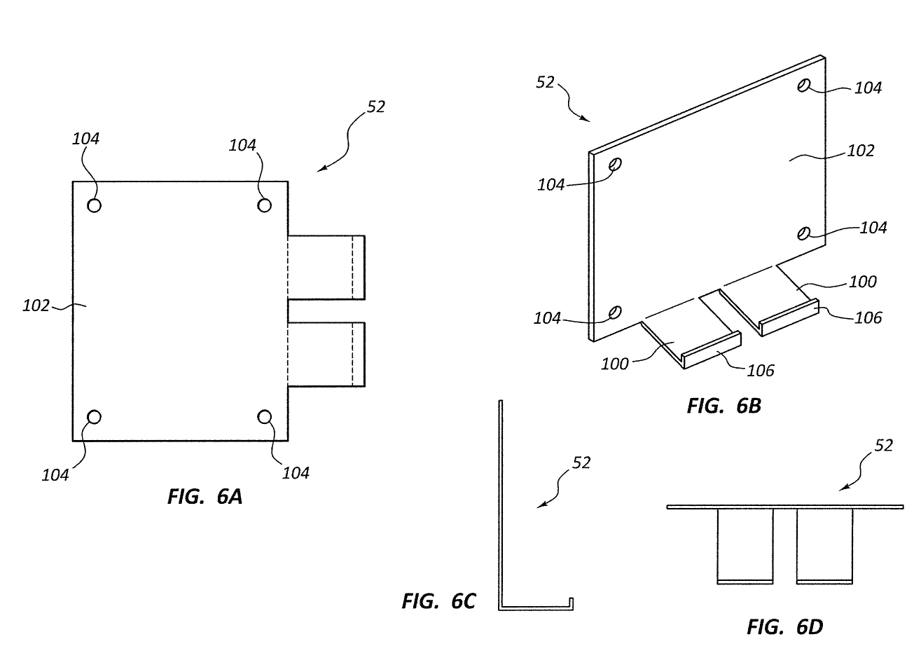

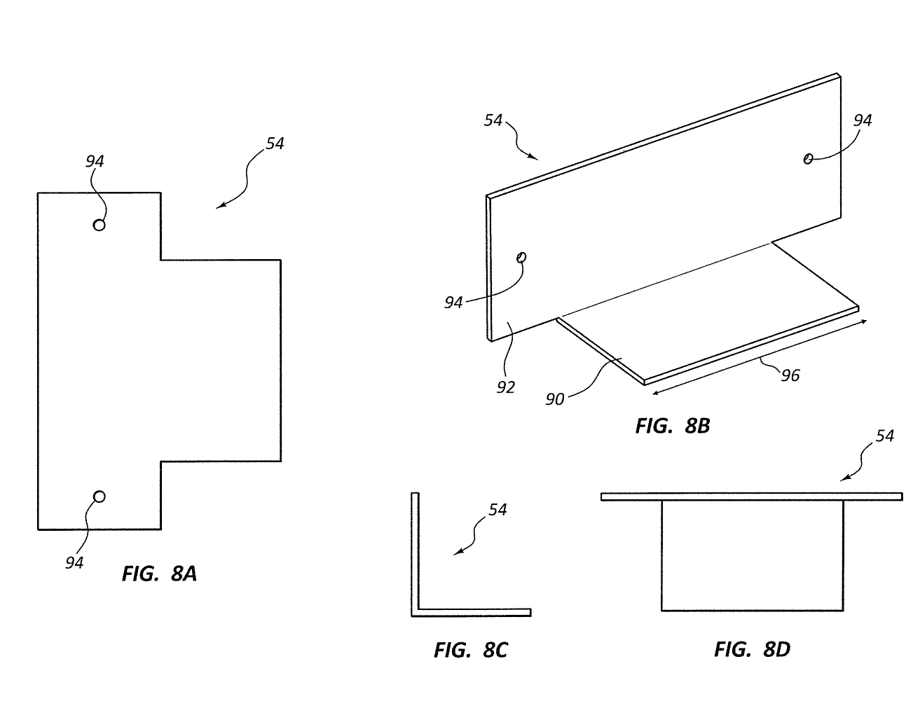

To facilitate the replacement and exchange of digital and static displays, in some embodiments, at least some of the mounting brackets 52 and 54 easily and quickly engage and release the cabinet 24 so that they can be quickly added, removed, moved, and adjusted. In this manner, the placement and orientation of the mounting brackets is modular, dynamic, and/or adjustable. For example, in some embodiments, at least some of the mounting brackets are interlocked to the cabinet via one or more channels, slots, grooves, protrusions, recesses, pins, or other like structures between the mounting brackets and the cabinet. In some embodiments, at least some of the mounting brackets 52 are selectively coupled to the cabinet 24 using removable fasteners, including screws, bolts, locking pins, and the like. In some embodiments, at least some of the mounting brackets are permanently coupled to the cabinet in locations and orientations where a mounting bracket is used by the cabinet 24 for receiving and/or retaining both the digital 40 and static 44 and 46 chassis. Accordingly, in some embodiments, the mounting brackets are rearranged or replaced when the digital and static displays are exchanged. FIGS. 6 and 8, which are described below, illustrate representative embodiments of mounting brackets 52 and 54.

A display chassis, including both the static 40 and the digital 44 and 46 chassis can be secured within the cabinet 24 in a variety of ways. In some embodiments, the display chassis includes a front and back portion, as shown in FIG. 2 with respect to both the static and the digital chassis. In some embodiments, these portions are individually attached to the cabinet 24, either by a fastener or via an interlock. In other embodiments, these portions are fastened or interlocker together after they are inserted into position within the cabinet. In this manner, the display chassis is not directly fastened to the cabinet, but can be indirectly fastened to the cabinet because the mounting brackets 52 are tightly sandwiched between the portions of the static chassis and secure the display chassis in a fixed position within the cabinet 24.

The addition of one or more doors 30 to the cabinet 24 provides another alternative method of securing the display chassis within the cabinet 24. As illustrated, in some embodiments, the display chassis is positioned and/or interlocked within the cabinet 24, but not completely secured therein. However, when a door 30 is closed, the door serves to secure the display chassis within the cabinet 24. In some embodiments, the door 30 is a frame-like structure that contacts the outer portions of the front of the display chassis and retains it within the cabinet 24 when the door is closed. The door can be locked to prevent accidental or unauthorized opening. In some embodiments, the cabinet 24 includes front and a back door, as shown. In other embodiments, the cabinet only includes a front door or a back door. The doors can be coupled to the cabinet 24 via one or more hinge disposed either at a side, a top, or a bottom of the cabinet. In other embodiments, the static chassis 40 is secured within the cabinet 24 using a combination of any of the aforementioned methods of securing it within the cabinet.

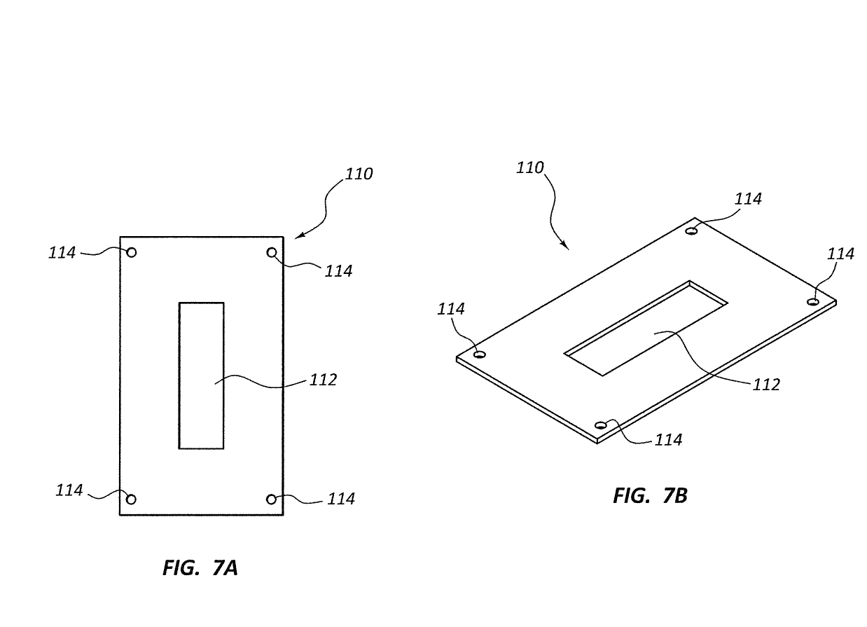

Referring now to the static display 12 of FIG. 2, as illustrated, the static display 12 includes a light source 42 that is positioned between a lower light bar 50 and an upper light bar 110 (shown in FIG. 7) positioned on the top of the front static chassis 40A. The light source 42 illuminates a display screen (not shown) that is coupled to the static chassis 40. In some embodiments, the light source 42 is positioned between the top and the bottom of the static chassis 40, and there is no lower light bar or upper light bar. Furthermore, in some embodiments, the light source 42 is integrated into the static chassis 40 such that it is connected to the chassis and is not installed as a separate component when the static and digital chassis are interchanged.

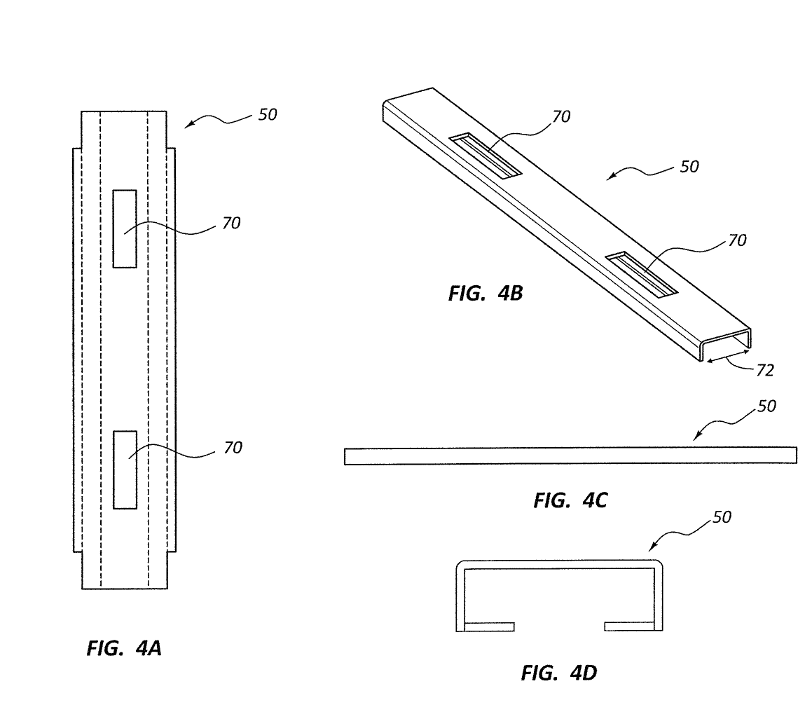

As shown, the light source 42 and the display cabinet 24 are enclosed between front 40A and back 40B portions of the static chassis. Thus, a user installing the static display 12 installs the light source 42 before the chassis 40. As illustrated, the lower light bar mounting brackets 54 are installed onto the cabinet 24 and the lower light bar 50 is attached to each bracket 54. FIGS. 4 and 8 illustrate representative embodiments of the lower light bar 50 and the lower light bar mounting bracket 54 respectively. FIG. 7 illustrates a representative view of an upper light bracket 110 having a hole 112 that is not shown in FIG. 2, and which supports a top portion of light source 42 within the static chassis 40. The light source 42 is coupled to the lower light bar 50. Next, the front 40A and rear 40B static chassis are each installed from their respective sides: the front static chassis 40A is installed from the front side, and the rear static chassis 40B is installed from the rear.

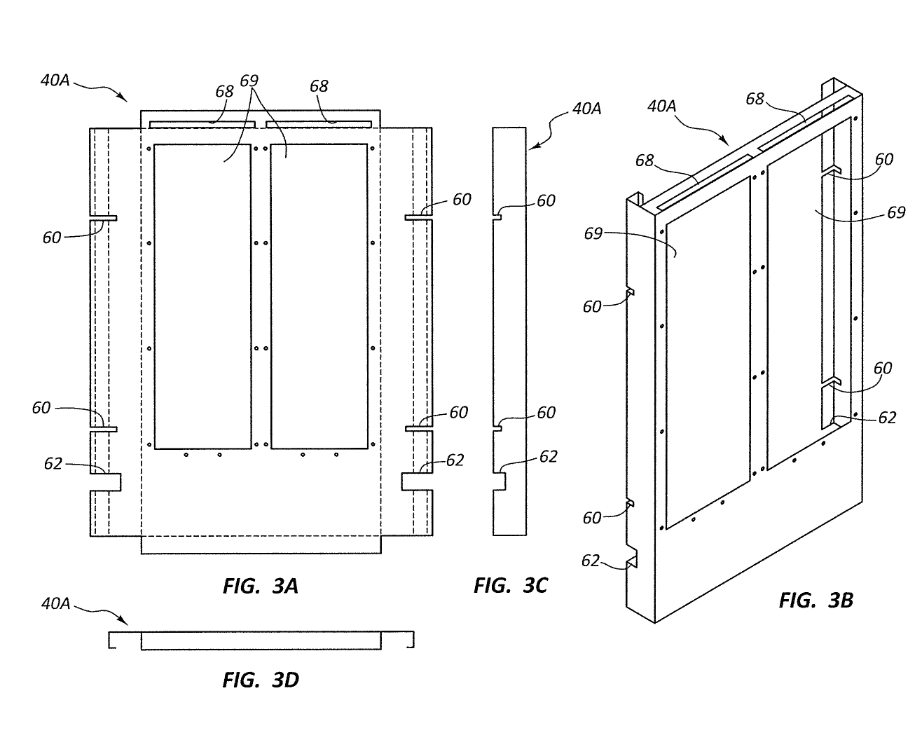

Referring now to FIG. 3, the front portion of the static chassis 40A is illustrated. As shown, this portion may be formed from a single piece of sheet metal, including aluminum, steel, stainless steel, and the like. The layout includes two display openings 64 that house a display screen, such as a semi-transparent screen. In other embodiments the chassis 40A includes only a single display opening 64 or three or more display openings 64. In some embodiments, slots 60 are disposed along the sides and/or top of the chassis 40A. Slots 60 can have a variety of shapes and sizes. In some embodiments, the slots 60 includes rectangular shaped cutouts that have inner dimensions approximately equal to the outer dimensions of corresponding mounting brackets 52 on the cabinet 24. As described above, these slots can mate with mounting brackets 52 on the cabinet 24. In other embodiments, slots 60 are located on the top and bottom of the chassis 40A. In other embodiments, more slots 60 are included on the chassis 40A. One particular slot, a lower light bar slot, 62 is shaped and sized to mate with at least a portion of the lower light bar 50. Other slots may be likewise included to mate with components of the cabinet or with particular mounting brackets.

FIG. 6 illustrates a representative mounting bracket 52 that may be coupled to the display cabinet 24 and receive a slot 60 of the static chassis 40 or digital chassis 44 and 46 and thereby support the static chassis 40. The illustrated mounting bracket 52 includes a support portion 100 that extends at approximately a right angle from a mounting portion 102. The mounting portion includes one or more mounting holes 104 through which a variety of fasteners can be inserted to fasten the mounting bracket 52 to the cabinet. The support portion 100 includes a lip 106 that can add additional support to the chassis from excessive lateral movement. It will be understood that the mounting bracket 52 can have a variety of other shapes, sizes, and configurations to mate with, receive, interlock, or otherwise support portions of a digital or static chassis.

Referring back to FIG. 3, in some embodiments, the static chassis 40 includes one or more top openings 68, as shown in FIG. 3. These top opening 68 may facilitate ventilation. The top opening 68 may additionally or alternatively allow for internal components, including a light source 42, or display screen to be inserted therethrough or coupled therein. In some embodiments, a display screen is selectively inserted through the top opening 68 and is tall enough so that the top of the display screen is positioned and retained within the top opening 68.

Referring again to FIG. 2, in some embodiments, the static chassis 40 includes a rear portion 40B that is coupled to the front portion 40A and which together retains the static display components therein. In some embodiments, the rear portion 40B is identical to the front portion 40A so that the static display is two-sided. In other embodiments, the rear portion 40 is nearly identical to the front portion 40A, but it has no display openings 64. In other embodiments, the rear portion 40 is structurally distinct to the front portion 40A. As will be understood from the discussion above, in some embodiments, one or more components of the static display 12 are housed between the front 40A and rear 40B portions of the static chassis. For example, in some embodiments, an upper and lower light bars/mounts, a light source, a display screen, and other supporting components are housed within the static chassis 40. Additional components may be included with the static display.

FIG. 4 illustrates various views of the lower light bar 50 that is positioned horizontally within the cabinet 24 and provides structural support to a light source 42. The lower light bar 50 supports the lower portion of the light source 42. In some embodiments, the lower light bar 50 includes one or more openings 70, which may correspond to the number of light sources 42 supported by the light bar. In some embodiments, the openings receive a light mount, or ballast, or other physical and/or electrical components necessary to support a light source. Accordingly, in some embodiment, a light source is coupled to the light mount on either the top and/or bottom light bars. In some embodiments, the lower light bar 50 is integrated into the static chassis 40 or the cabinet 24. In other embodiments, the lower light bar 50 is located within the static chassis at a distance above the bottom of the chassis, as shown. In some embodiments, the lower light bar 50 is adjustable, such that it can be fastened to the static chassis 40 at variable heights within the static chassis 40.

As discussed above, in some embodiments, the lower light bar 50 is coupled to the lower light bar mount 54. FIG. 8 illustrates one embodiment of the lower light bar mount 54. This mount 54 can be selectively fastened to the static chassis 40 at various heights along the sides of the chassis 40. In some embodiments, this mount 54 includes a support portion that extends from a mounting portion 92 at approximately a ninety degree angle. In other embodiments, this angle is another angle between 1-179 degrees. As further illustrated, this mount 54 includes two mounting holes 94 useful in inserting a screw, pin, or other fastener therethrough to couple the mount 54 to the chassis 40. In still other embodiments, the mount 54 is fastened or interlocked to the chassis 40 in other ways, as described herein. In some embodiments, the length 96 of the mounting portion is approximately equal to the length 72 of the channel formed by the lower light bar (shown in FIG. 4) so that the lower light bar 50 fits snuggly over the lower light bar mount 54. In this manner, the lower light bar 50 can receive and be supported by the lower light bar mount 54. It will be understood that the lower light bar mount 54 can have a variety of shapes, sizes, and configurations to mate with, receive, interlock, or otherwise support the lower light bar.

Reference will now be made to the digital display 14 of FIG. 2. As illustrated, the digital display includes a digital chassis 44 and 46 that is inserted into the cabinet 24. The digital chassis can be supported and secured within the cabinet using any other methods and structures described above, including the use of a door (not shown). In some embodiments, the digital chassis includes a front portion 44 and a back portion 46. In some embodiment both portions include a digital display device, for example a LCD display device, and thus the display is two-sided. In other embodiments, only the front portion 44 includes a display device, as shown.

The front portion of the digital chassis 44 can include a digital display device integrated within the chassis. In other embodiments, the digital display device is a separable component that can be removed from the chassis and even replaced if necessary. A variety of digital display devices can be used depending on the needs of the display unit. This digital display provides moving and static video capabilities to the modular display. Accordingly, in some embodiments, the display can present live-video feeds to the digital display. In other embodiments, movies, television broadcasts, commercials, and/or changing display screens are presented on the digital display.

From the foregoing it will be seen that the modular display, as described herein, allows a display structure to be quickly and efficiently changed from a digital display to a static display or vice versa without replacing the entire display structure. Such versatility enables a rapid and frequent modification of a display system that may create vitality and freshness to business, storefront, or drive-thru experience.

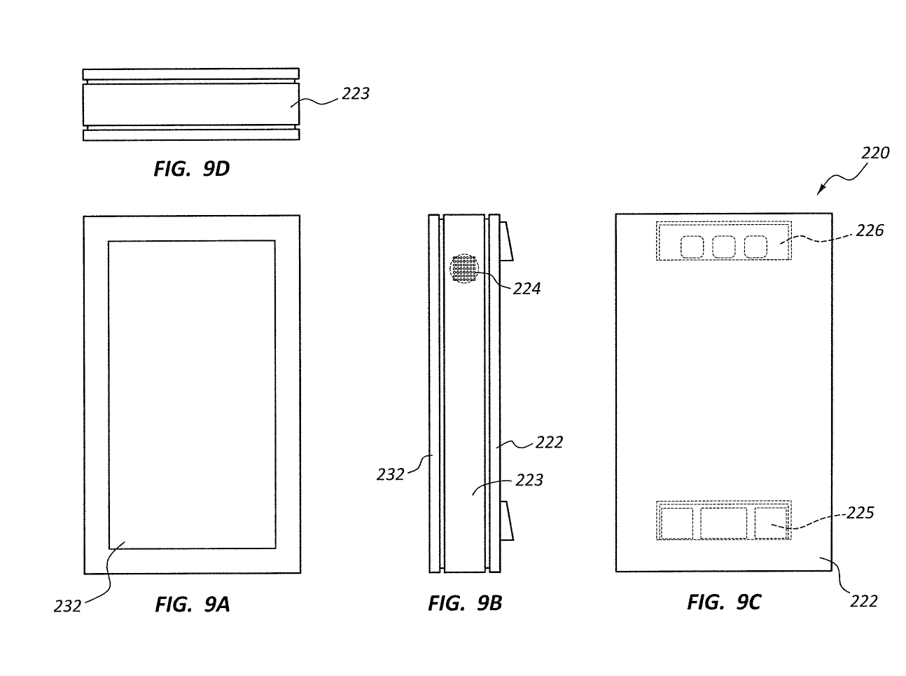

Additional aspects of a display cabinet with a modular digital display 220 are depicted in FIGS. 9-20, according to some embodiments. The modular digital display 220 has replaceable components, and an accessible structure that allows it to be serviced on-site so that repairs can be made efficiently, timely, and at minimal cost.

Referring to FIG. 9, which illustrates some basic exterior views of a display cabinet 220 according to an embodiment of the invention. As shown, a display cabinet 220 can have a front door 232, a rear door 222, and at least two side members 223 (that can be integral portions of the display cabinet 220). As shown, in some embodiments, the front door 232 is rectangular and at least partially supports an LCD screen 204. The front door 232 can have an opening equal to or larger than the screen portion of the LCD screen 204.

When placed outdoors, display cabinets 220, which have an enclosed housing, can overheating and/or have moisture problems. These problems are exacerbated by the use of internally backlit signs or signs that utilize internal mechanical features that utilize electricity as a source of power. Electrically powered internal components create heat, increase condensation and impair functioning. Accordingly, FIGS. 9-20 depict display cabinets 220 and cabinet components that can reduce or remove the problems of overheating and moisture. In some instances, a display cabinet 220 includes a cooling system that includes a fan assembly 227 having one or more fans, and vents 224 and 225 on side members 223 or the rear access panel 222. As shown, the display cabinet 220 can be substantially rectangular, to accommodate a rectangular LCD screen. In other embodiments, the display cabinet 220 is square, circular, or has other shapes that are suitable for display units.

As depicted in FIG. 9, embodiments of a display cabinet 220 can include exterior vents on side members 223 and utilize air intake vents 224 and 225 as well as air exhaust vents 226 on the rear access panel 222, to allow air to be drawn into the display cabinet 220 through the cabinet by the fan assembly 227 and out of air exhaust vents 226. As shown, some air intake vents can comprise larger holes 225 or openings in the cabinet 220, while other air intake vents 224 can be screened openings or a set of small holes.

The air intake vent(s) 224 and 225 and the exhaust vents 226 can be located away from each other, such as in opposite portions of the panel 220, to encourage air flow through the entire display cabinet 220. For example, in some configurations, one or more air intake vents 225 are located on a bottom portion of the rear door 222, and the exhaust vents 226 are located on a top portion of the rear access panel 222. In other configurations, the exhaust vents 226 are located on a bottom portion of the rear door 222, and the intake vent 225 is located on a bottom portion of the rear access panel 222. In still other configurations, the exhaust vents 226 are located on a side portion of the rear door 222, and the intake vent 225 is located on an opposite side portion of the rear door 222 to encourage air movement from one side to the other.

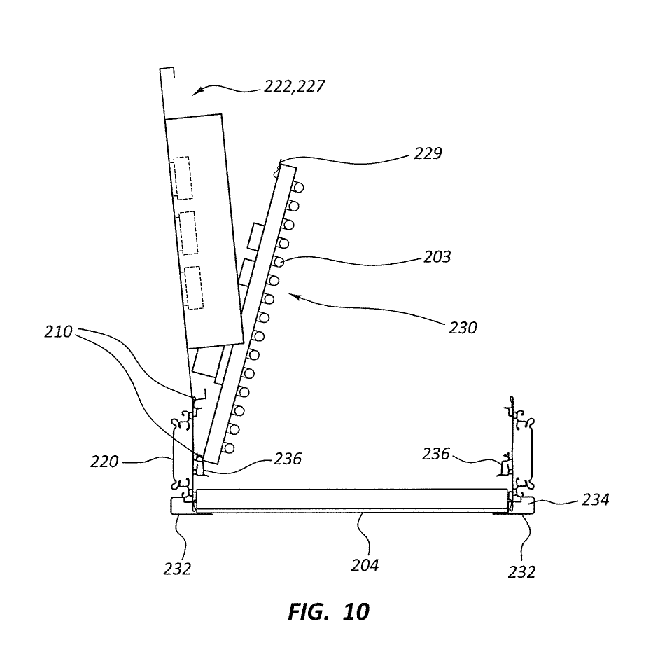

FIG. 10 is a top sectional view of an embodiment of a digital chassis 236that depicts several components of the cabinet 220 being hingedly coupled to a digital chassis 236. As shown, one or more internal components of the cabinet 220 are also connected via a hinge point of a hinge assembly 210, so that these components can be selectively opened, in a layer-by-layer fashion. The hinge assembly 210 can include one or more hinges that are coupled to the digital chassis 236. The hinge assembly can include a set of individual hinges coupled to the digital chassis 236 or a set of hinges coupled to a plate or other structure.

The ability to selectively open these panels/layers enables individual panels and components of these panels to be maintained, repaired, and otherwise serviced individually. Without the ability to access these individual panels and components, servicing the cabinet 220 would be more cumbersome and costly. The hinged nature of this configuration thus enables on-site servicing of the cabinet when problems arise with the cabinet 220 or maintenance is required.

Reference will now be made to the specific parts illustrated in FIG. 10. As depicted in the top sectional view, a display cabinet 220 houses a digital chassis 236. The display cabinet 234 includes a front door 232 and a having a rear door 222. In some configurations, as a shown, the front 232 and/or rear door 222 are connected to the digital chassis 236 via a hinge of a hinge assembly 210. As such, these door can open outwards, such that a person working on the display stands behind the display to access its internal components.

In some embodiments, a lamp assembly panel 203 and associated lamp assembly electrical components are also disposed on a panel that is hingedly coupled to the digital chassis 236. Accordingly, a user can access the lamp assembly 203 and electric components 230 as well as to an LCD display 204 by opening around the pivot point, thus gaining access to interior elements of the digital chassis 236 since the other components are moved to the side. Furthermore, in some instances, the LCD display 204 is also coupled to the digital chassis 236 via the hinge assembly 210.

Additionally, in some configurations, a fan assembly 227 is also hingedly coupled to the digital chassis 236 via a hinge assembly 210, such that it can be opened in order to gain access to internal components of the cabinet 220. By enabling this panel to be removed, maintenance personnel can access internal components without having to work around or through or remove the fan assembly 227. In some embodiments, the fan assembly 227 is coupled to the rear door 222 such that the two open and close together. In other embodiments, the fan assembly 227 and the rear door 222 comprise separate components, each individually hinged to the digital chassis 236 on separate pivotable panels.

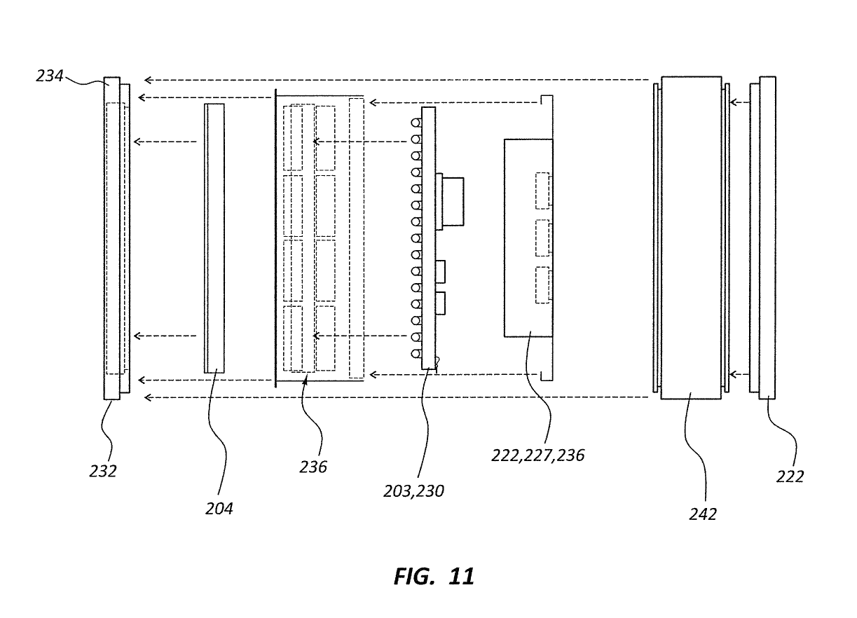

FIG. 11 provides another illustration of the layer-by-layer nature of the display cabinet 220, according to some configurations. As shown, the display cabinet 220 contains internal components that are installed therein on pivotable panels or layers. In some configurations, the display cabinet 220 includes the following components, which are assembled and secured into the cabinet body 242: a front door 232, an LCD display 204 that is bonded to glass, the digital chassis 236, the lamp assembly panel 203 with the corresponding electrical components 203, the digital chassis 236, rear door 222, and the fan assembly 227. In some embodiments, each of these components is removable and replaceable, permitting the entire display cabinet 220 to be serviced on-site, without requiring removal of the entire cabinet when diagnose or repair is required.

From the foregoing it will be seen that a display cabinet 220, according to some embodiments, can have a number of features and components that allow the entire display device to be serviced, maintained, and repaired on-site. For instance, the module display cabinet 220 can facilitate the interchange between digital 14 and static 12 displays. Furthermore, the nature hinged panels of the digital display can permit selectively opened, in a layer-by-layer fashion of the internal components of the digital display. The hinged panels permit replacement of individual panels or components within each panel. The on-site serviceable nature of the cabinet 220, according to some embodiments, increases the usefulness and overall value of the cabinet 220. In some instances, the ability to be serviced on-site can reduce maintenance cost, maintenance down-time, and the overall efficiency of the display cabinet as a business asset.

Reference will now be made to the specific parts illustrated in FIG. 11. As shown, the cabinet 220 can comprise a front door 232. In some embodiments, the front door 232 has a rectangular-frame shape, as shown in FIG. 9. The shape of the opening in the rectangular-frame-shaped retainer 232 can be approximately equal to the shape of the display screen of the LCD display 204. A front door 232 can allow access to the LCD display unit 204 from the front so that a user does not have to access the LCD display unit 204 through the rear door 222. For example, by opening the front door retainer 232, the LCD display can be accessed and subsequently removed, replaced, or repaired.

In some configurations, the front door retainer 232 comprises frame brackets 234 that can assist in structurally supporting the LCD display unit 204. The frame brackets 34 can be structured for coupling to the cabinet. In some configurations, the frame brackets 234 are coupled to a hinge assembly 210 allows the front door retainer 232 to open and close in a door-like fashion. As shown, in some configurations, the frame bracket 234 is a hollow member having a bracket extension 250 that extends perpendicularly from the frame bracket 234 to the interior of the cabinet 220. This bracket extension 250 can provide lateral support to the LCD display 204 that can prevent the LCD display 204 from falling out the front of the cabinet 220. In some embodiments, the frame bracket includes walls disposed at right angles to each other, and an interior wall that abuts a LCD display 204 and supports the display within the cabinet 234.

As depicted in the top view assembly of FIG. 11, the LCD display 204 can be affixed to the front door retaining unit 232, which can itself be opened to allow access to internal components of the display. In other instances, the LCD display 204 is not affixed to the front door retaining unit 232, but rather statically or hingedly coupled to the digital chassis 236 or the display cabinet 220.

In some embodiments, the LCD display 204 can be bonded to IR and Anti-reflective (AR) glass. LCD display devices in exterior environments face difficulty under ambient light and heat. Heating of the LCD panel either by the various constitutive electronic units interior the cabinet or by direct sunlight causes clearing, in which the LCD screen goes black. Clearing can be avoided by bonding IR and/or AR glass to the exterior surface of the LCD display, as well as by utilizing a cabinet cooling system 205. Reducing radiant heat absorbed by the LCD display 204 by effective removal of hot air from the interior of the cabinet body 242 can be desired.

In addition to the use of IR/AR glass, the LCD display 204 can benefit from a cooling system that removes hot air within the display cabinet 220. As illustrated in FIG. 10, the cooling system can cool the cabinet by channeling air through one or more air channels 211 that passes through the interior elements of the display cabinet 220. The cooling system can allow for free flowing air, or forced air, to move through the interior body and around the constitutive elements of the display cabinet 220. Embodiments of the cooling system 240 can comprise a fan assembly 227, an air channel 211, intake vents 224 and 225, and/or exhaust vents 226.

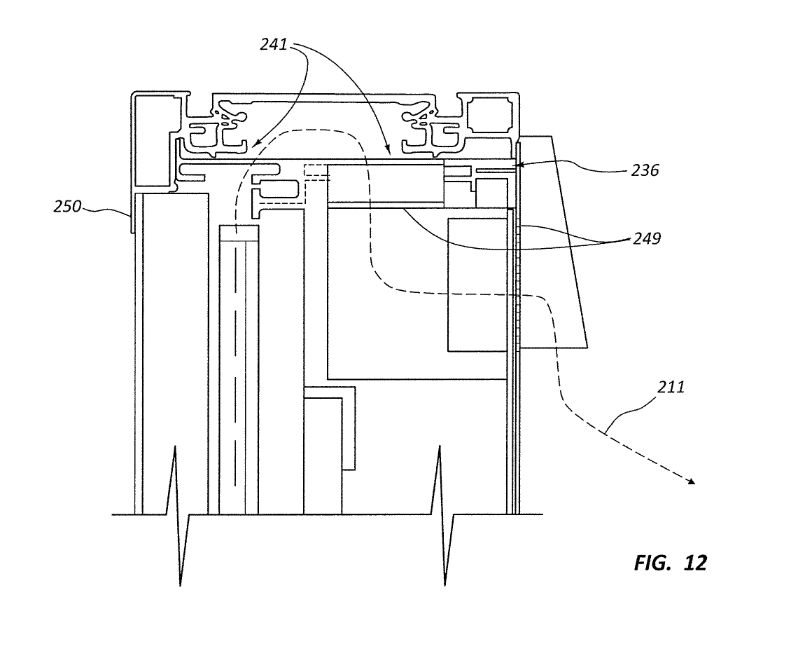

In some configurations, one or more air channels 211 are disposed between the lamp assembly panel 230 and the LCD display 204 and/or the rear door retainer 22. For instances, one or more air channel, such as a gap, channel, or series of channels, is disposed between the lamp assembly panel 230 and the LCD display 204. In some embodiments, this air channel includes a gap between the components of the lamp assembly panel 230 and the LCD display 204. In some embodiments, this gap is at least 3mm in width at its smallest distance. In other embodiments, this gap ranges between 1 mm and 2cm. As shown in FIG. 12, this air channel can be in fluid communication with the fan assembly 227 so that air can be circulated between these two components.

In some embodiments, a fan assembly 227 can be fixed at a point near the rear air intake vents 225 and/or near the rear air exhaust vents 226. Slots 241 can be provided and located within the chassis body 236 to allow air to move between the various constitutive elements of the display cabinet 230 and through the chassis body 236. In some embodiments, these slots 241 are located in the top and bottom of the chassis body 236. In other embodiments, these slots are located in the top and bottom as well as through the middle of the chassis body 236. In particular, slots 241 can be formed through the interior portion of the chassis body 236 that support the sides (as opposed to the front or back) of the internal components (including the lamp assembly 230 and LCD display 204).

To further facilitate air flow through the cabinet, one or more air channels 211 can be disposed between top, bottom, and or sides of the lamp assembly panel 230 and/or the LCD display 204. In some embodiments, this air channel 211 is a gap, while in other embodiments, this air flow channel is a hole or set of holes.

In some configurations, such as that shown in FIG. 12, slots 241 are positioned so as to be between the LCD display and the lamp assembly 230, between the lamp assembly 230 and the rear door retainer 422, and/or at both of these locations. Furthermore, as also shown in FIG. 12, in some embodiments, the chassis body 236 includes a hollow portion that forms an air channel 211 between two or more slots 241 within the chassis body 236 to enable airflow therethrough. In some instances, the two or more slots 241 are located at approximately the same height on the chassis body 236, while in other embodiments, these slots 241 are located at difference heights. Still, in other embodiments, a large number of slots 241 (e.g. ten or more) are disposed at various heights along the chassis body 236 forming various air channels 211 therethrough. In some embodiments, one or more fans are located at approximately the same height on the chassis body 236 a slot 241 between the lamp assembly 230 and the rear door retainer 422, in order to introduce air flow therethrough.

As depicted in FIG. 11, the chassis body 236 can be coupled to a rear door 222 having a fan assembly 227. The fan assembly 227 can comprise a plurality of cooling fans 227. In some embodiments, only one fan can be utilized. In other embodiments two, three, four, five, ten, twelve, fifteen, or more fan units can be utilized in order to accommodate and provide cooling air flow through the display cabinet 220. In some embodiments, the fans blow air into the display cabinet 220, while in other embodiments, the fans suck air out of the display cabinet 220. In some embodiments, one or more fans blow air into the display cabinet 220 while one or more other fans suck air out of the display cabinet 220.

A cabinet body 242 can selectively receive and house the chassis body 236, as mentioned. The cabinet body 242 can be constructed of various materials, including weather resistant metals, painted metals, plastics, composites, etc. The cabinet body 242 can also provide support for both chassis body 236 and other elements of the display cabinet 220 contained therein. In some instance, the rear door retaining element 222 and front door retaining element 232 can be attached to the chassis body 236 of the cabinet body 242, hingedly or otherwise.

FIG. 12 also depicts a gasket seal 249 that seals the opening of the fan assembly 227. Furthermore, in some embodiments, one or more other openings in the cabinet 220 can include a gasket seal 249 that provides a water-tight seal to the cabinet to protect the cabinet from water and other environmental conditions.

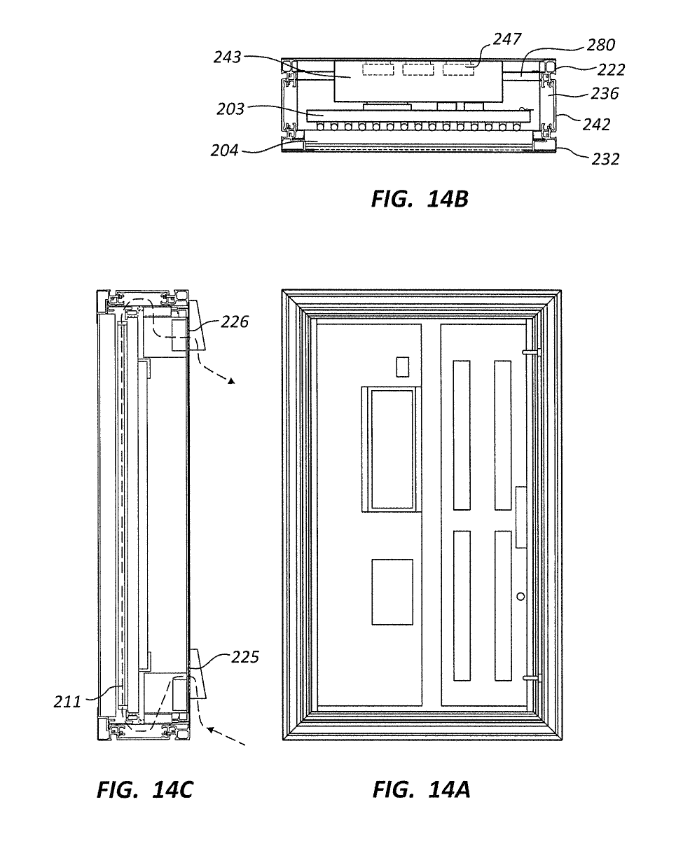

FIG. 14 depicts a sectional view of a display cabinet 220 at the cabinet's center. Embodiments of a display cabinet 220 can comprise an air intake vent 225, one or more air channel 211 and air exhaust vent 226 to allow free passage of air through the cabinet to provide for cooling of the various elements contained within the cabinet body, allowing for temperature control of the interior elements of the cabinet body. Maintaining control over the temperature of the interior cabinet the interior of the cabinet can effectively increase longevity of mechanical units contained on the interior of the cabinet as well as increase the probability that an LCD display unit 204 will provide adequate visual display, even under direct sunlight. The cooling system of the cabinet can be coupled to one or more fans 227 to force air through the channel system 211 from the air intake vent 225 to the air exhaust vent 226. In some instances, the cooling system can force air in from the bottom of the cabinet 220 and out through the top of the cabinet in order to remove hot air that tends toward the top of the cabinet. In some embodiments, an air filter may be provided at the air intake vents to decrease the flow of contaminants into the display cabinet 220.

FIG. 14 also provides a top sectional view of an embodiment of a display cabinet 220 comprising a front door 232, wherein the front door 232 utilizes at least two frame brackets 234 for fixing the front door 232 to the chassis body 236. The front door 232 can be coupled to the cabinet body 242. Hingedly connecting the front door 232 to the cabinet body 242 can allow the components internal the front door retaining unit 232 to be exposed when necessary, while maintaining a connection to the cabinet body 242. Providing a connection between the LCD display 204 and the front door retainer 232 allows for the incorporation of various LCD display units to a display cabinet 220.

Furthermore, from this top sectional view, it can be seen that in some configurations, the cabinet includes large open spaces 280 between the lamp assembly 203 and the rear door 222 to facilitate air flow there between. Furthermore, this view illustrates the benefits of slots 241 through the chassis body 236 that can open up a fluid path 211 between the front and rear portions of the lamp assembly 203.

A lamp assembly 203 can be utilized in conjunction with the LCD display unit 204 providing backlighting or lighting to other display features surrounding the LCD display unit, enhancing both the capacity of the menu display cabinet to provide information as well as to increase the aesthetic value of the cabinet body itself 242. In some embodiments, an independent chassis body 243 can be utilized to house a fan assembly 247. The independent chassis body 243 can be fixedly or hingedly attached to a rear door 222. Similar to the construction of the front retaining door 232, the rear door retaining unit 222 can utilize frame brackets 234 designed to hingedly affix the independent chassis body 43 and affixed rear door retaining unit 222 to the cabinet body 228 and/or the chassis body 236. Hinged attachment of the rear door retaining unit 222 to the chassis body 236 and/or the cabinet body 228 allows the constitutive elements coupled to the rear retaining unit 222 to be hingedly opened and accessed for mechanical upkeep and/or replacement.

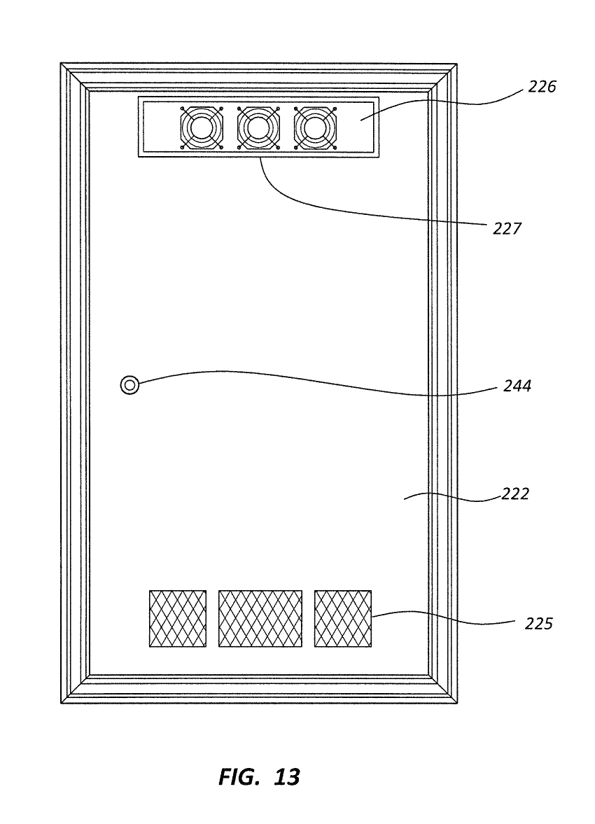

FIG. 13 depicts a back view of the cabinet, and in particular the rear door, in accordance with some embodiments. The rear door 222 can comprise air intake vents 225, air exhaust vents 226, a fan assembly 227, and a lock 244. Use of a lock or latch on the rear door can permit periodic opening of the chassis door back panel, while preventing or reducing theft and vandalism. As depicted, the cooling system can comprise at least three cooling fans. As depicted in FIG. 13, three cooling fans can be utilized, but in other embodiments, five, ten, or more cooling fans can be utilized, and in other embodiments, one fan can be utilized to force air through the air intake vents 235 to air channels 211 and out through the air exhaust vents 226.

FIG. 14 further depicts specific details of the electrical components 230 on a lamp assembly panel 203, according to one embodiment. As shown, in some embodiments, the electrical components 230 include a thermostat control, a ballast, a power supply (e.g. a 120 V ac/12 V DC power supply), a row terminal block (e.g. a dual row terminal block), a power disconnect, and a video control board. In some embodiments, the thermostat control is disposed on the top of the lamp assembly panel 203. The thermostat control can be functionally connected to the cabinet cooling system to allow for accurate measurement and control of the internal temperature of various components of the display device. In some configurations, when the internal temperature reaches a threshold value, the thermostat control initiates the cabinet cooling system to cool the cabinet to below a predetermined value.

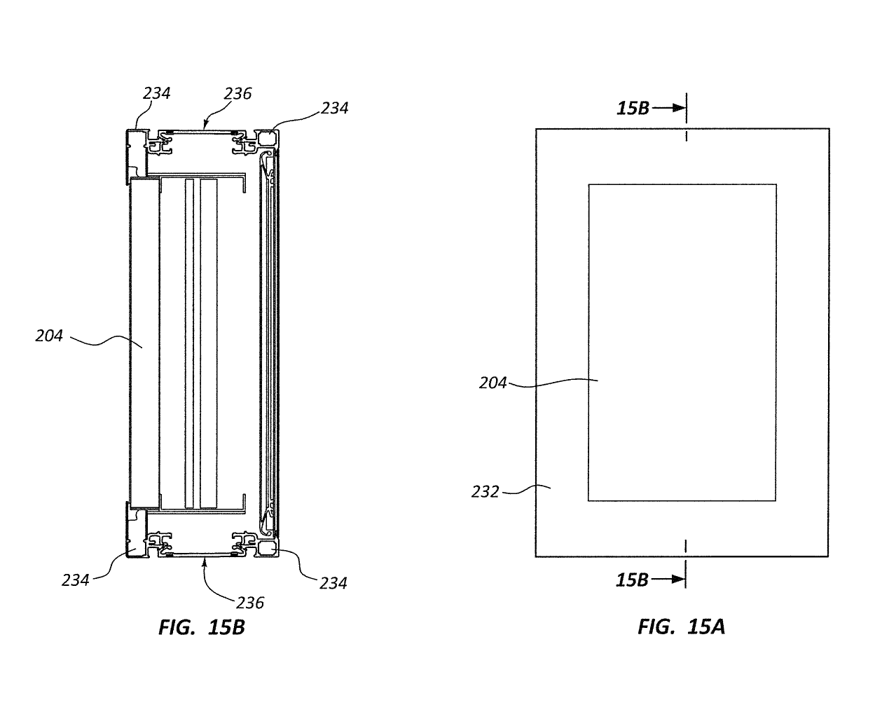

FIG. 15 provides both a front view and a top cutaway view of various elements of display cabinet 220, including an LCD panel 204 bonded to IR and/or AR glass coupled to the front door 232. The front door 232, as depicted, can be hingedly attached to a digital chassis 236. The digital chassis 236, front door retaining units 221, rear door retaining units 222 and frame brackets 234 are all preferably made from aluminum extruded in a cross sectional shape shown in the drawings. It is understood that the frame sections could also be made in other configurations and from other materials, such as suitable plastic materials.

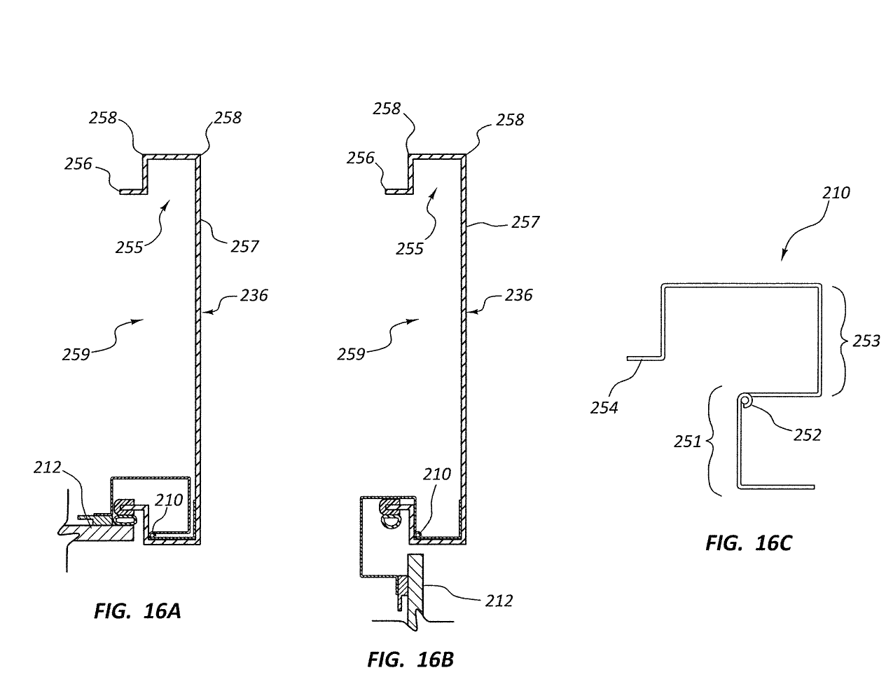

FIG. 16 illustrates an embodiment of one embodiment of a hinge of the hinge assembly 210 within a digital chassis 236 in a closed and open position. The depicted hinge can be made of various elements or manufactured out of any desired metal, plastic or carbon fibered product. In order to prevent the doors from being improperly removed, hinged members 245 can be formed into the configurations shown so they can only be assembled and dissembled by authorized personnel. As illustrated, the hinged members 242 can be couple the front door 232 and/or the rear door 222 to the digital chassis 236 and/or the cabinet body 242 of a display cabinet 220.

Specifically, the hinge assembly 210 is formed of an L-shaped member 251, a pivot member 252, and a swinging member 253. The L-shaped member 251 is substantially L-shaped and is coupled to the digital chassis 236. The pivot member 252 is disposed at an end of the L-shaped member at enables the swinging member 253 to pivot about the pivot member 252. The swinging member 253 can be configures as shown in FIG. 27, having four right-angle bends that form an incomplete rectangle. The swinging member 253 can be coupled to a panel, door, LCD display, or other component via the swinging member extension 254, which extends outwardly from the swinging member. The hinge assembly 210 of FIG. 27 allows the pivot member 252 to be disposed within a recess 255 of the digital chassis 236, which can provide structural support.

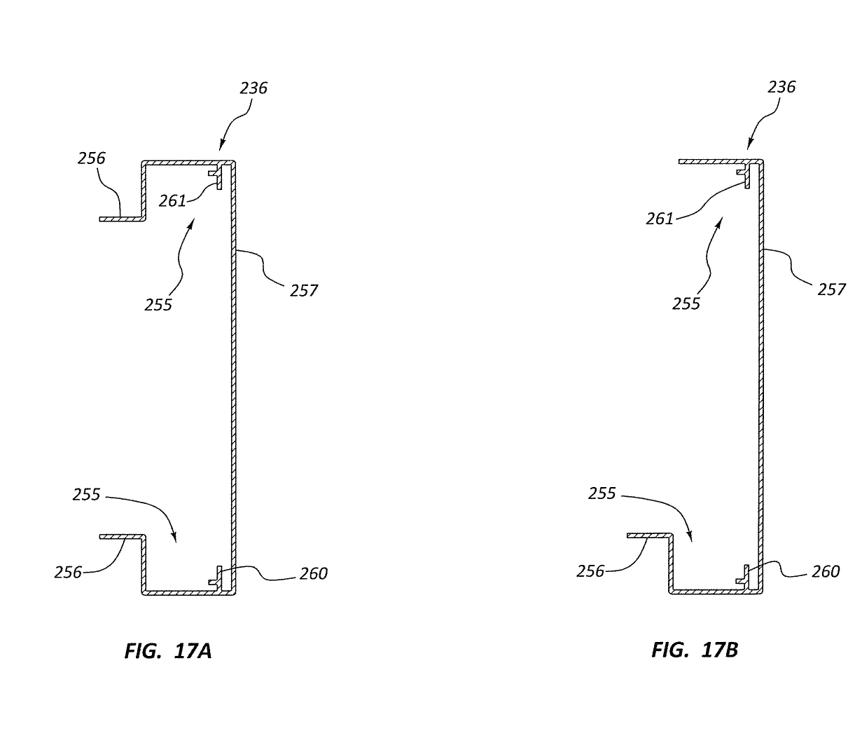

FIG. 17 also illustrates a cross-sectional view of a digital chassis 236 according to some embodiments. As shown, the digital chassis 236 can have a substantially C-shape with two body extensions 256 directed inwardly. In some embodiment, the chassis body is formed of substantially right angles. The digital chassis 236 includes a straight portion 257 that defines the depth of the chassis body. At each end of the straight portion 257, the digital chassis 236 has two right-angle bends 258 that form a recess 256. Thus configured, the digital chassis 236 forms a pocket 259 between the two body extensions 256 and the recesses 256. The components of the cabinet 220 can be coupled within the pocket 259. This configuration can provide strength and functionality to the display cabinet 220.

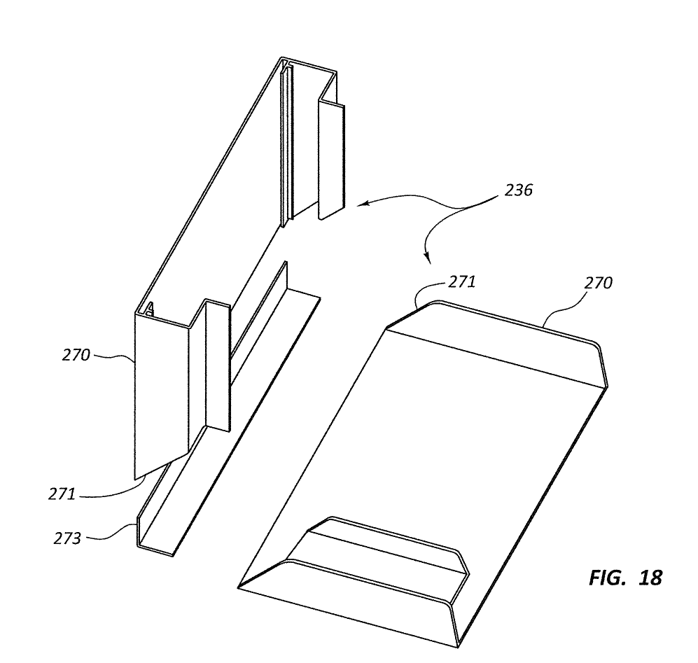

FIG. 18 illustrates a double face cabinet according to various embodiments. Each face is comprised of the sides forming the recess 256 and a body extension 256. In some embodiments, the digital chassis 236 includes only a single recess, thus forming a single face cabinet, as shown. Furthermore, in some embodiments, the digital chassis 236 includes an inward extension 260 or 261 disposed parallel to the straight portion 257. This inward extension can be linear or T-shaped as shown.

FIG. 18 further illustrates the junction of two double-faced sides 270 of the digital chassis 236 to form a corner of the digital chassis 236. As shown, in some configurations, two sides of the chassis body 270 are cut at an angle (e.g. approximately a forty-five degree angle) to form an angled portion 271. The cut portions 270 are coupled together along the angles portion 271. A corner member (comprised of an L-shaped portion of material) receives the two sides of the chassis body 270 and supports the junction. In some embodiments, the two sides 271 are welded together. In other embodiments, the two sides 271 are coupled together with a brad, screw, or other such fastener. In some embodiments, the digital chassis 236 is formed of extruded aluminum material.

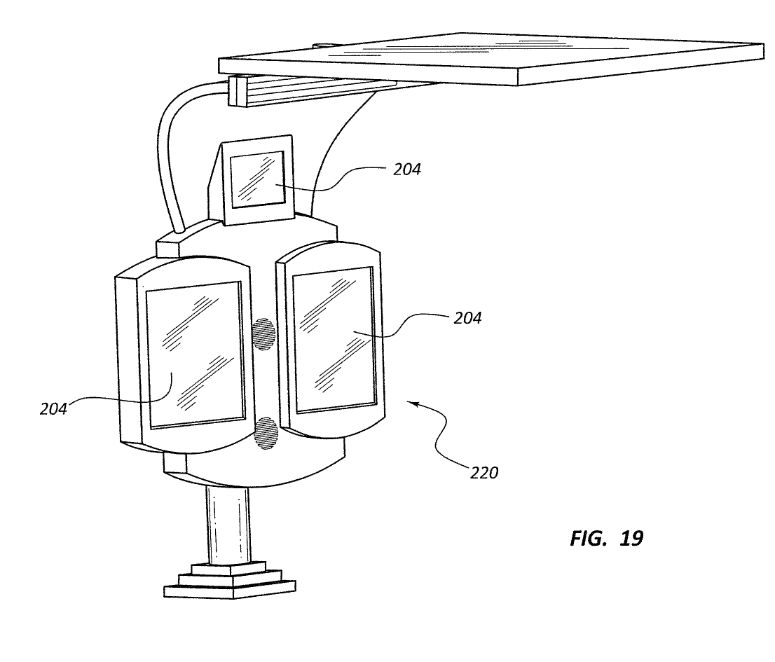

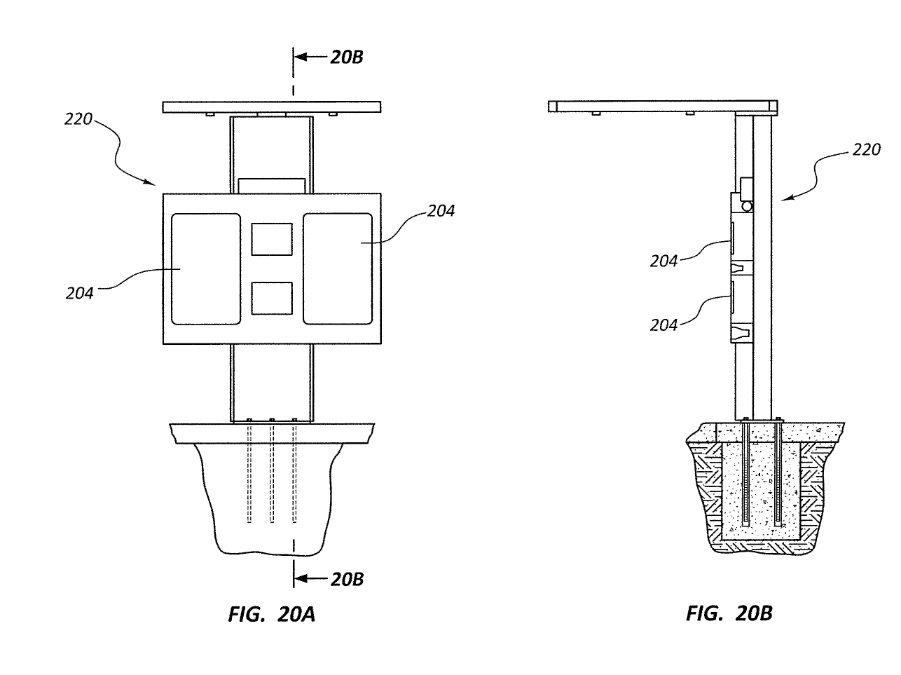

FIGS. 19 and 20 illustrate exterior cabinets 220 with multiple LCD screens 204 according to some embodiments.

The present invention may be embodied in other specific forms without departing from its structures, methods, or other essential characteristics as broadly described herein and claimed hereinafter. The described embodiments and examples are all to be considered in every respect as illustrative only, and not as being restrictive. The scope of the invention is, therefore, indicated by the appended claims, rather than by the foregoing description. All changes that come within the meaning and range of equivalency of the claims are to be embraced within their scope.

1. A modular display comprising:
a cabinet having an external frame
a display chassis being shaped and sized to be selectively inserted into and selectively coupled to the external frame of the cabinet, wherein the display chassis is selected from a group consisting of a static display chassis and a digital display chassis;
the static display chassis housing a static light source and a static display; and
the digital display chassis housing a digital display.

2. The modular display of claim 1, wherein the external frame further comprises a plurality of mounting brackets disposed thereon.

3. The modular display of claim 2, wherein the display chassis further comprises a plurality of slots shaped and sized to mater with the plurality of mounting brackets.

4. The modular display of claim 1, further comprising at least one door coupled to the cabinet and shaped and sized to retain the display chassis within the cabinet when moved to a closed position.

5. The modular display of claim 1, wherein the digital display is a LCD display.

6. A display cabinet comprising:
a lamp assembly hingedly attached to a digital chassis contained within a display cabinet;
an LCD display coupled to the digital chassis; and
a cooling system comprising air intake vents, air exhaust vents and air channels throughout the interior of the display cabinet, one of the air channel being between the LCD display unit and the lamp assembly.

7. The display cabinet of claim 6, wherein the digital chassis comprises slots accommodating the flow of air through the digital chassis.

8. The display cabinet of claim 7, wherein at least one of the slots is between the LCD display unit and the lamp assembly, and wherein another of the slots is between the lamp assembly and a rear door.

9. The display cabinet of claim 6, wherein the LCD display is hingedly attached to the digital chassis.

10. The display cabinet of claim 6, wherein the LCD display is attached to a front door.

11. The display cabinet of claim 6, further comprising a rear door.

12. The display cabinet of claim 6, further comprising at least one cooling fan.

13. The display cabinet of claim 6, wherein the LCD display includes IR glass or AR glass bonded thereto.

14. The display cabinet of claim 6, further comprising a thermostat control device.
